(19) United States
(12) Patent Application Publication
(10) Pub. No.: US 2026/0191181 A1
(43) Pub. Date: Jul. 9, 2026

(54) HYDRAULIC CONTROL SYSTEM FOR A SPRAYER BOOM ON AN AGRICULTURAL FIELD SPRAYER

(71) Applicant: Voith Patent GmbH, Heidenheim (DE)

(72) Inventor: Steffen Antoni, Hambrücken (DE)

(73) Assignee: Voith Patent GmbH, Heidenheim (DE)

(21) Appl. No.: 19/532,033

(22) Filed: Feb. 6, 2026

Related U.S. Application Data
(63) Continuation of application No. PCT/EP2024/069283, filed on Jul. 9, 2024.

(30) Foreign Application Priority Data
Aug. 8, 2023 (DE) 10 2023 121 074.2
Jul. 9, 2024 (WO) PCT/EP2024/069283

(51) Int. Cl. A01M 7/00; F15B 13/02; F15B 13/06; F15B 15/14

(52) U.S. Cl. CPC A01M 7/0057; F15B 13/027; F15B 13/06; F15B 15/1447

(57) ABSTRACT

A hydraulic control system includes a first hydraulic cylinder and a second hydraulic cylinder; a first proportional valve assigned only to the first hydraulic cylinder and connected via a first operating pressure line; a second proportional valve assigned only to the second hydraulic cylinder and connected via a second operating pressure line. The first proportional valve and the second proportional valve are each configured as a 4/3 proportional directional control valve which has two operating ports. One operating port is connected to a corresponding operating pressure line and the other operating port is connected to a respective control pressure line. A first hydraulic check valve is provided in the first operating pressure line and a second hydraulic check valve is provided in the second operating pressure line. The first and second hydraulic check valves are each connected with at least one of the control pressure lines.

### CROSS REFERENCE TO RELATED APPLICATIONS

This is a continuation of International Patent Application No. PCT/EP2024/069283 entitled “HYDRAULIC CONTROL SYSTEM FOR A SPRAYER BOOM ON AN AGRICULTURAL FIELD SPRAYER,” filed on Jul. 9, 2024, which is incorporated in its entirety herein by reference. International Patent Application No. PCT/EP2024/069283 claims priority to German Patent Application No. 10 2023 121 074.2 filed on Aug. 8, 2023, which is incorporated in its entirety herein by reference.

### BACKGROUND OF THE INVENTION

### 1. Field of the Invention

The invention relates to a hydraulic control system for adjusting the profile of a sprayer boom on an agricultural field sprayer, and to a sprayer boom with a corresponding hydraulic control system.

### 2. Description of the Related Art

Field sprayers with sprayer booms serve to uniformly apply liquid substances, especially plant treatment agents, onto an agricultural target surface area. In a field, this area may, for example, be the soil or the plant itself. For uniform distribution of the applied substances over the entire width of the sprayer boom, it must be possible to adjust the distance between the sprayer boom and the target surface area. It is important, especially with very wide sprayer booms, to adapt the tilt and profile of the sprayer boom to a slope or to different crop heights. To adjust the profile, the boom arms can be swiveled around a pivot axis and can thus be angled upward or downward.

Such sprayer booms and a control system for adjusting the tilt and the profile are described in principle, for example, in DE 202011111069 U. A vertically adjustable main frame is provided on the field sprayer to adjust the general distance of the sprayer boom to the target surface area. The sprayer boom is made up of a center section and two lateral boom arms. By means of hydraulic cylinders the tilt of the center section of the sprayer boom, and thus the entire sprayer boom, can be adjusted relative to the main frame. In addition, the arms which are respectively mounted on a pivot point on the center section, can be angled upward or downward by means of an actuator. This means that they are swiveled up or down to change the horizontal profile of the sprayer boom. The actuators are controlled with separate levers. The control system is not described further.

A hydraulic control system for such a sprayer boom is described in more detail in EP 3753407 A1. The variants shown therein have the disadvantage of requiring numerous electronic outputs to control the various valves. For example, the three control valves and three check valves shown require six electronic outputs. On the one hand, this requires a considerable expenditure in wiring and on the other hand, it is also susceptible to malfunctions under harsh operating conditions.

Additional variants of hydraulic control systems for sprayer booms are known, for example from EP 3629725 A1. It is described therein as to how, without a center section and using only two boom arms, both the tilt and the profile of the sprayer boom can be adjusted via a control system with two hydraulic cylinders. The disadvantage of this design is that the combination of tilt and profile adjustment requires a complex circuitry configuration of the control valves. This results in high costs for the hydraulic piping. Moreover, the suspension of the two boom arms is inadequately implemented, as a very large hydraulic accumulator would be necessary to reliably decouple the tilt of the boom arms from vibrations or fluctuations of the vehicle.

What is needed in the art is a simpler hydraulic control system for a sprayer boom, as well as a corresponding sprayer boom, which can be implemented cost-effectively and be reliably operated.

### SUMMARY OF THE INVENTION

In some embodiments provided according to the invention, a hydraulic control system for adjusting a profile of a sprayer boom on an agricultural field sprayer, the sprayer boom having a center section, a first boom arm, and a second boom arm, which are respectively pivot mounted laterally to the center section via a pivot axis, is provided. The control system includes: a first hydraulic cylinder and a second hydraulic cylinder for angling up and angling down the first boom arm and the second boom arm, respectively, about respective pivot axes, the first hydraulic cylinder and the second hydraulic cylinder each being double-acting and having a respective cylinder housing and a piston with a piston rod movable therein, where a first cylinder chamber and a second cylinder chamber are created in the cylinder housing, the first cylinder chamber and the second cylinder chamber being separated by the piston; a first proportional valve assigned only to the first hydraulic cylinder such that the first proportional valve is connected via a first operating pressure line only to the second cylinder chamber of the first hydraulic cylinder; a second proportional valve assigned only to the second hydraulic cylinder and connected via a second operating pressure line only to the second cylinder chamber of the second hydraulic cylinder, where no additional operating pressure lines connect the first proportional valve and the second proportional valve to the first hydraulic cylinder and the second hydraulic cylinder. The first proportional valve and the second proportional valve are each configured as a 4/3 proportional directional control valve with four ports and three switching positions, each of which has two operating ports, one pressure port, one tank return port, and only one solenoid coil. One operating port is connected to the corresponding operating pressure line and the other operating port is connected to a respective control pressure line. A first hydraulic check valve is provided in the first operating pressure line and a second hydraulic check valve is provided in the second operating pressure line. The first hydraulic check valve and the second hydraulic check valve are each connected with at least one of the control pressure lines.

In some embodiments provided according to the invention, a sprayer boom for an agricultural field sprayer for controlled application of fluid onto a target surface area includes: a vertically adjustable main frame configured to be rigidly attached to a vehicle frame of a machine; a center section attached tiltably to the main frame via a rotational axis; a first boom arm and a second boom arm, each of which is attached laterally on the center section via a respective rotational axis; an additional double-acting hydraulic cylinder provided on the sprayer boom, with which tilting of the center section relative to the main frame can be adjusted; and a control system. The control system includes: a first hydraulic cylinder and a second hydraulic cylinder for angling up and angling down the first boom arm and the second boom arm, respectively, about respective pivot axes, the first hydraulic cylinder and the second hydraulic cylinder each being double-acting and having a respective cylinder housing and a piston with a piston rod movable therein, where a first cylinder chamber and a second cylinder chamber are created in the cylinder housing, the first cylinder chamber and the second cylinder chamber being separated by the piston; a first proportional valve assigned only to the first hydraulic cylinder such that the first proportional valve is connected via a first operating pressure line only to the second cylinder chamber of the first hydraulic cylinder; a second proportional valve assigned only to the second hydraulic cylinder and connected via a second operating pressure line only to the second cylinder chamber of the second hydraulic cylinder, where no additional operating pressure lines connect the first proportional valve and the second proportional valve to the first hydraulic cylinder and the second hydraulic cylinder. The first proportional valve and the second proportional valve are each configured as a 4/3 proportional directional control valve with four ports and three switching positions, each of which has two operating ports, one pressure port, one tank return port, and only one solenoid coil. One operating port is connected to the corresponding operating pressure line and the other operating port is connected to a respective control pressure line. A first hydraulic check valve is provided in the first operating pressure line and a second hydraulic check valve is provided in the second operating pressure line. The first hydraulic check valve and the second hydraulic check valve are each connected with at least one of the control pressure lines.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 schematically illustrates a design example of a sprayer boom provided according to the invention; and

FIG. 2 schematically illustrates a design example of a hydraulic control system provided according to the invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The sprayer boom provided according to the invention has a center section and a first and second boom arm, which are respectively pivot mounted laterally to the center section via a pivot axis. The control system comprises a first and a second hydraulic cylinder for angling up and angling down the boom arms about the pivot axis, both of which are double-acting and respectively have a cylinder housing and a piston with a piston rod movable therein, whereby a first and a second cylinder chamber are formed in the cylinder housing, separated by the piston. The control system moreover includes a first proportional valve, which is assigned only to the first hydraulic cylinder, and a second proportional valve, which is assigned only to the second hydraulic cylinder, such that the first proportional valve is connected via a first operating pressure line only to the second cylinder chamber of the first hydraulic cylinder, and the second proportional valve is connected via a second operating pressure line only to the second cylinder chamber of the second hydraulic cylinder, and no additional operating pressure lines connect the proportional valves to either of the two hydraulic cylinders.

The design according to the invention has two proportional valves respectively that are designed as 4/3 proportional directional control valves with four ports and three switching positions, each of which has two operating ports (A, B), a pressure port (P), a tank return port (T), and only one solenoid coil. One operating port (A) is connected to the corresponding operating pressure line and the other operating port (B) is connected to a control pressure line. A first hydraulic check valve is provided in the first operating pressure line and a second hydraulic check valve is provided in the second operating pressure line. The two check valves are each connected to at least one of the control pressure lines.

A significant advantage of the design provided according to the invention is that the circuitry configuration requires only two electronic outputs for profile adjustment, namely one for each of the 4/3 proportional directional control valves to actuate the solenoid coil. The check valves do not require any further electronic signals, as they are hydraulically actuated by the 4/3 proportional directional control valves via the control lines, in other words being unlocked. This particular control system can be implemented more cost-effectively and with less effort than known control systems. It is also very robust and dependable.

The hydraulic check valves are designed in such a way that they are unlocked when a control pressure is applied and release the return flow from the corresponding cylinder chamber of the hydraulic cylinder. If there is no control pressure, the check-valves shut off the return flow. This means that as long as there is no control pressure, the check valves lock the respective hydraulic cylinder and the boom arm is held in its current position. If the check valves are released via the control pressure, the corresponding boom arm is lowered. And if the hydraulic cylinder is supplied with operating pressure via the proportional valve, the boom arm is raised.

With the inventive design, the boom arms and their hydraulic cylinders can be controlled individually and independently of each other via the respectively assigned proportional valve. If the respective hydraulic cylinder is pressurized via the operating pressure line in the second cylinder chamber by switching the assigned proportional valve to the appropriate switching position, the boom arm is angled upwards. This means that the boom arm pivots upwards around the pivot axis, whereby the hydraulic cylinder is retracted.

The pressure port of the proportional valves is connected to a pressure supply or pressure source. This may, for example, be a pressure source for constant pressure supply or a load-sensing pump. The tank return port is connected to a hydraulic tank, so that draining hydraulic fluid can flow into the hydraulic tank.

In some embodiments, the two hydraulic cylinders are arranged in such a way that the first cylinder chamber is always the so-called piston chamber and that the second cylinder chamber, which is connected to the operating pressure line, is always the so-called annular chamber. The annular chamber is understood to be the cylinder chamber that is penetrated by the piston rod, and the piston chamber is the cylinder chamber on the other side of the piston. Accordingly, the annular chamber has a smaller piston pressure area than the piston chamber, which has the entire surface of the piston as a piston pressure area. The advantage of this arrangement is that the cylinder housing with its ports for the operating pressure lines is connected to the center section and not to the moving boom arms. This means that the ports remain relatively stationary during piston extension and the connected operating pressure lines do not have to be designed as flexibly.

In some embodiments, the first check valve is connected to the first proportional valve via the control pressure line, so that it can be unlocked via this control pressure line, and the second check valve is connected to the second proportional valve via the control pressure line, so that it can be unlocked via this control pressure line. This means that the two check valves respectively can also be controlled individually and independently of the one respectively assigned proportional valve.

In some embodiments, the first cylinder chamber of the first hydraulic cylinder is connected with the first cylinder chamber of the second hydraulic cylinder via a connecting line, and said connecting line is connected to a hydraulic tank via a drain line, wherein another hydraulic check valve is provided in this drain line. The two hydraulic cylinders to be locked by this additional check valve, confining the hydraulic fluid in the first cylinder chambers of the two hydraulic cylinders. Thus, the two boom arms can be held rigid in the current position, even if all operating pressure lines are depressurized. For example, if the external forces on the hydraulic cylinders are reversed by dynamic processes during spraying. The boom arms can, moreover, be held rigidly in the angled position when the field sprayer is not working but is being transported or driven on the road. For this purpose, there is a transport position in which the boom arms are tied up and in addition are folded in laterally.

In some embodiments, this additional check valve is connected via a control pressure line with both proportional valves, whereby a shuttle valve is provided in this control pressure line which is arranged between the first proportional valve and the second proportional valve so that the control pressure line to the additional check valve can be pressurized by the first or second proportional valve, depending on the switching state and the pressure level. Thus, the additional check valve can be controlled individually and independently by each of the two proportional valves and can thus be unlocked. Therefore, each boom arm can be controlled and raised individually and independently by the assigned proportional valve. The shuttle valve is designed so that it releases the control line that has the higher pressure.

To achieve suspension and damping of the pivoting movement of the boom arms, a hydraulic accumulator may be provided branching off from the operating pressure line, each of which is connected to the operating pressure line via a flow resistor. Due to the size and the gas-side filling pressure in the hydraulic accumulator, the suspension can be adjusted and the damping is achieved through the flow resistor. Thus, unwanted vibrations of the boom arms can be suppressed. The flow resistor can for example be designed as a throttle. The hydraulic accumulator is designed so that it comprises an enclosed gas volume.

In some embodiments provided according to the invention, a sprayer boom includes an inventive control system as previously described. In addition to the control system, the inventive sprayer boom includes the following components:
a vertically adjustable main frame, and otherwise rigidly attached to a frame of the machine,
a center section, which is attached tiltably to the main frame via a rotational axis,
a first and second boom arm, each of which is attached laterally on the center section via a rotational axis, wherein the boom arms can be angled upward and downward by a first or second double-acting hydraulic cylinder that is provided on the sprayer boom, and
an additional double-acting hydraulic cylinder on the sprayer boom, with which tilting of the center section relative to the main frame can be adjusted.

The characteristic features and associated advantages arise analogously from the advantages already described for the control system. Additional advantageous features for the sprayer boom are described further herein.

Additionally, it may be advantageous if the first and second double-acting hydraulic cylinders are arranged so that the respective cylinder housing is pivotally connected with the center section, and the respective piston and its piston rod are pivotally connected with the respective boom arm. Thus, the connections for the operating pressure lines on the cylinder housing remain relatively stationary when the piston is extended.

In some embodiments, a further hydraulic control system is provided which controls the further hydraulic cylinder, wherein this further control system comprises an operating pressure line to the further hydraulic cylinder and, branching off from it, a hydraulic accumulator which is connected to this operating pressure line via a throttle. This provides the center frame with suspension and damping so that vibrations and fluctuations are not transmitted from the vehicle to the sprayer boom. Additional suspension and damping for the pivot movement of the boom arms is thus no longer necessary, which simplifies the control system of the boom arms.

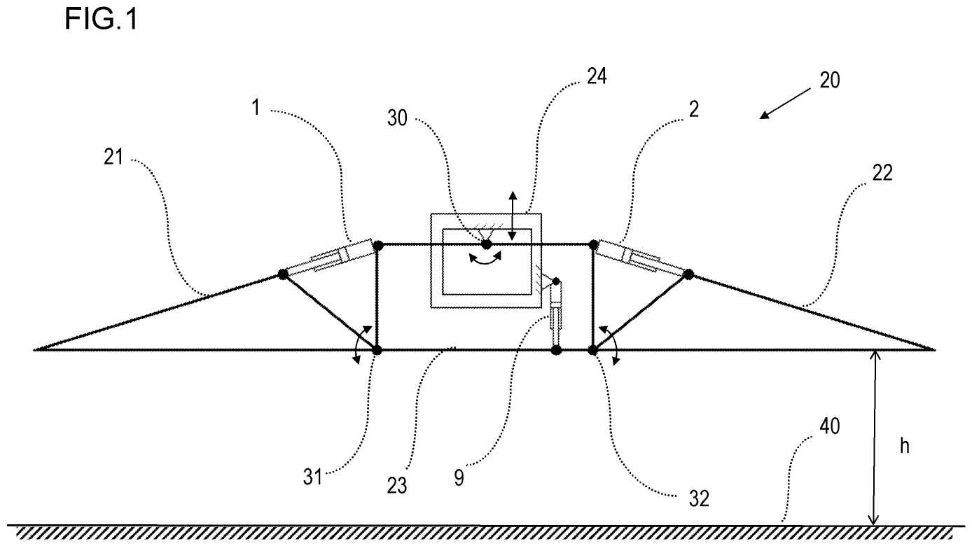

Referring specifically now to the drawings, FIG. 1 is a schematic representation of one exemplary embodiment of a design of spray boom 20 provided according to the invention with a hydraulic control system provided according to the invention. Main frame 24 is connected to the field sprayer in a vertically height adjustable manner. This can be a self-propelled field sprayer, a trailer for a tractor, or an accessory equipment mounted on a tractor. Distance h to target surface area 40 can be set by the vertical height adjustment. In a field, target surface area 40 can be, for example, the ground or the plant itself.

Sprayer boom 20 comprises center section 23 and two boom arms 21, 22. In the shown design example, center section 23 is rotatably mounted on main frame 24 about axis of rotation 30. The tilt of center section 23, and thus of spray boom 20, relative to main frame 24 and therefore to the vehicle, can be adjusted by additional hydraulic cylinder 9. The additional control system for additional hydraulic cylinder 9 can include a hydraulic accumulator, which is connected to the operating pressure line to additional hydraulic cylinder 9 via a throttle. The throttle provides damping, and the hydraulic accumulator provides spring action. Center section 23, and thus the spray boom, are thereby decoupled from vibrations and fluctuations of the vehicle.

The two boom arms 21, 22 are each attached to center section 23 via pivot axis 31, 32. They are also connected to center section 23 via double-acting hydraulic cylinders 1, 2 and can be angled up or down independently of each other by extending and retracting the pistons. In addition to the tilt, the profile of spray boom 20 can also be adjusted to adapt spray boom 20 as uniformly as possible to the contour of target surface area 40. The objective is for distance h to the target area to be as uniform as possible across the width of entire spray boom 20 and to be at least within a specified distance range.

The two hydraulic cylinders 1, 2 are installed in such a way that the cylinder housing is connected to center section 23 and the piston and piston rod are connected to respective boom arm 21, 22.

If entire sprayer boom 20 is spring-loaded and damped relative to main frame 24, the control system for boom arms 21, 22 does not require spring loading and damping.

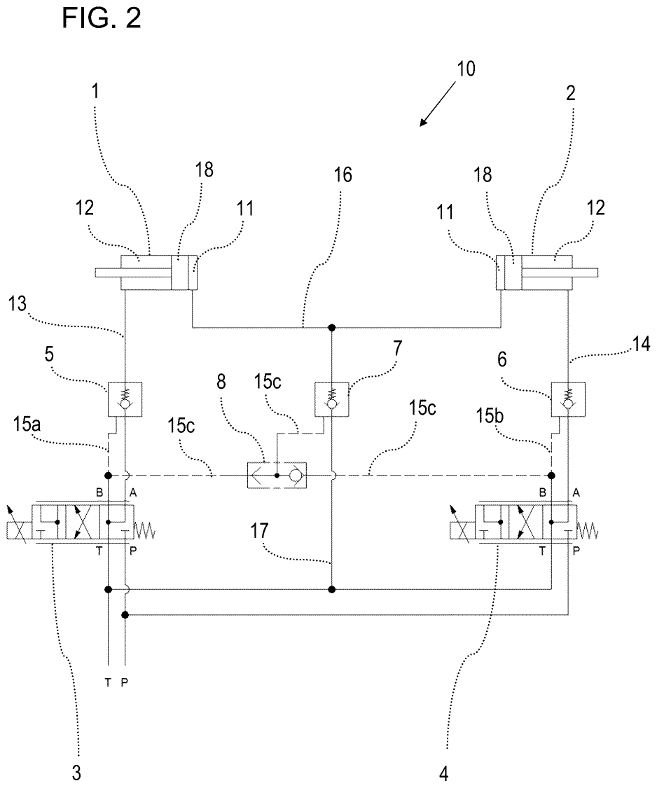

FIG. 2 is a schematic representation of a hydraulic control system 10 provided according to the invention for boom arms 21, 22. Double-action hydraulic cylinders 1, 2 each have a cylinder housing with two connections and a movable piston 18 located inside, wherein the cylinder housing in the illustrated version is connected to center section 23. On one side of piston 18 the piston rod is attached, which in the version shown is connected to respective boom arm 21, 22.

Hydraulic cylinder 1, 2 has a first and a second cylinder chamber 11, 12 in the cylinder housing, which are separated by piston 18 and which are respectively assigned to one of the ports on the cylinder housing. Second cylinder chamber 12 is always located on the side of piston 18 that is connected to boom arm 21, 22; and first cylinder chamber 11 is located on the side that is connected to center section 23. In other words, when second cylinder chamber 12 is pressurized, boom arm 21, 22 is angled upward, in other words, raised.

In the illustrated design, second cylinder chamber 12 is the so-called annular chamber, which is penetrated by the piston rod. First cylinder chamber 11 is the piston chamber. The piston chamber has a larger piston pressure area than the annular chamber that forms around the piston rod.

Alternatively, hydraulic cylinders 1, 2 could also be installed in reverse to the configuration shown, in which case the first cylinder chamber would be the annular chamber and the second cylinder chamber would be the piston chamber.

Control system 10 moreover comprises first and second proportional valves 3,4, both of which are designed as 4/3 proportional directional control valves—each with two operating ports A, B, pressure port P, which is connected to a pressure source, and tank return port T, which is connected to a hydraulic tank. These proportional valves 3,4 each have only one solenoid coil. Therefore, they can be controlled with a single electronic input and switched between the three switching positions. This eliminates the need for complex circuitry configuration.

Second cylinder chamber 12 of respective hydraulic cylinder 1, 2 is connected respectively via operating pressure line 13, 14 with operating port A of associated proportional valve 3, 4. If proportional valve 3, 4 is switched so that operating port A is connected to the pressure source, second cylinder chamber 12 is pressurized and boom arm 21, 22 is angled upward.

Check valves 5, 6 prevent boom arm 21, 22 from lowering again unintentionally. Each proportional valve 3,4 is connected via respective control pressure line 15a, 15b—which is connected to operating port B—to hydraulic check valve 5, 6 assigned to it. When control pressure line 15a, 15b is pressurized, corresponding check valve 5,6 is unlocked, so that hydraulic fluid can flow out of second cylinder chamber 12. Corresponding boom arm 21, 22 is then angled down.

In the design illustrated herein, an additional hydraulic check valve 7 is provided, which is arranged in drain line 17. Drain line 17 connects connecting line 16 between the respective first cylinder chambers 11 of the two hydraulic cylinders with the hydraulic tank. When one of the boom arms 21, 22 is angled downward, piston 18 of corresponding hydraulic cylinder 1, 2 moves, and hydraulic fluid is drawn from the hydraulic tank into first cylinder chamber 11 via check valve 7. If one of the boom arms 21, 22 is to be angled upward, check valve 7 is unlocked via control line 15c, so that hydraulic fluid can flow out of corresponding first cylinder chamber 11.

Control line 15c is connected to first and also second proportional valves 3, 4 in that it is connected to respective operating port B. In this respect, control line 15c may also be referred to as a “common control pressure line” or “common control line.” In control line 15c, between the two proportional valves 3, 4, shuttle valve 8 is provided, which releases control line 15c from the side of change-over valve 8 on which the greater pressure is applied. Thus, first hydraulic cylinder 1 can be raised or lowered independently by first proportional valve 3, and second hydraulic cylinder 2 can be controlled independently by second proportional valve 4.

When check valve 7 is locked, the hydraulic fluid is trapped in first cylinder chambers 11 of hydraulic cylinder 1, 2. This allows boom arms 21, 22 to be held in position even if the operating pressure lines to the hydraulic cylinders are depressurized.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

Component identification listing

| | |
|---|---|
| 1 | first hydraulic cylinder |
| 2 | second hydraulic cylinder |
| 3 | first proportional valve |
| 4 | second proportional valve |
| 5 | first check valve |
| 6 | second check valve |
| 7 | additional check valve |
| 8 | shuttle valve |
| 9 | additional hydraulic cylinder |
| 10 | control system |
| 11 | first cylinder chamber |
| 12 | second cylinder chamber |
| 13 | first operating pressure line |
| 14 | second operating pressure line |
| 15, 15 a, b, c | control pressure lines |
| 16 | connecting cable |
| 17 | drain line |
| 18 | piston |
| 20 | sprayer boom |
| 21 | first boom arm |
| 22 | second boom arm |
| 23 | center section |
| 24 | main frame |
| 30 | axis of rotation |
| 31 | first rotational axis |
| 32 | second rotational axis |
| 40 | target area |
| h | distance to the target area |

What is claimed is:

1. A hydraulic control system for adjusting a profile of a sprayer boom on an agricultural field sprayer, the sprayer boom having a center section, a first boom arm, and a second boom arm, which are respectively pivot mounted laterally to the center section via a pivot axis, the control system comprising:
a first hydraulic cylinder and a second hydraulic cylinder for angling up and angling down the first boom arm and the second boom arm, respectively, about respective pivot axes, the first hydraulic cylinder and the second hydraulic cylinder each being double-acting and having a respective cylinder housing and a piston with a piston rod movable therein, whereby a first cylinder chamber and a second cylinder chamber are created in the cylinder housing, the first cylinder chamber and the second cylinder chamber being separated by the piston;
a first proportional valve assigned only to the first hydraulic cylinder such that the first proportional valve is connected via a first operating pressure line only to the second cylinder chamber of the first hydraulic cylinder;
a second proportional valve assigned only to the second hydraulic cylinder and connected via a second operating pressure line only to the second cylinder chamber of the second hydraulic cylinder, wherein no additional operating pressure lines connect the first proportional valve and the second proportional valve to the first hydraulic cylinder and the second hydraulic cylinder, wherein the first proportional valve and the second proportional valve are each configured as a 4/3 proportional directional control valve with four ports and three switching positions, each of which has two operating ports, one pressure port, one tank return port, and only one solenoid coil, wherein one operating port is connected to the corresponding operating pressure line and the other operating port is connected to a respective control pressure line;
a first hydraulic check valve provided in the first operating pressure line; and
a second hydraulic check valve provided in the second operating pressure line, wherein the first hydraulic check valve and the second hydraulic check valve are each connected with at least one of the control pressure lines.

2. The control system of claim 1, wherein the first cylinder chamber is always a piston chamber and the second cylinder chamber, which is connected to the respective operating pressure line, is always an annular chamber that is penetrated by the piston rod.

3. The control system of claim 1, wherein the first check valve is connected to the first proportional valve via the respective control pressure line and can be unlocked via the respective control pressure line, and the second check valve is connected to the second proportional valve via the respective control pressure line and can be unlocked via the respective control pressure line.

4. The control system of claim 1, wherein the first cylinder chamber of the first hydraulic cylinder is connected with the first cylinder chamber of the second hydraulic cylinder via a connecting line and the connecting line is connected to a hydraulic tank via a drain line, whereby an additional hydraulic check valve is provided in the drain line.

5. The control system of claim 4, wherein the additional check valve is connected with both the first proportional valve and the second proportional valve via a common control pressure line and a shuttle valve is provided in the common control pressure line which is arranged between the first proportional valve and the second proportional valve so that the common control pressure line to the additional check valve can be pressurized by the first proportional valve or the second proportional valve depending on a switching state and a pressure level.

6. The control system of claim 1, further comprising a hydraulic accumulator respectively branching off from each of the operating pressure lines, each of the hydraulic accumulators being connected to its respective operating pressure line via a flow resistor.

7. The control system of claim 6, wherein the flow resistor is a throttle.

8. A sprayer boom for an agricultural field sprayer for controlled application of fluid onto a target surface area, the sprayer boom comprising:
a vertically adjustable main frame configured to be rigidly attached to a vehicle frame of a machine;
a center section attached tiltably to the main frame via a rotational axis;
a first boom arm and a second boom arm, each of which is attached laterally on the center section via a respective rotational axis;
an additional double-acting hydraulic cylinder provided on the sprayer boom, with which tilting of the center section relative to the main frame can be adjusted; and
a control system comprising:
a first hydraulic cylinder and a second hydraulic cylinder for angling up and angling down the first boom arm and the second boom arm, respectively, about the respective pivot axes, the first hydraulic cylinder and the second hydraulic cylinder each being double-acting and having a respective cylinder housing and a piston with a piston rod movable therein, whereby a first cylinder chamber and a second cylinder chamber are created in the cylinder housing, the first cylinder chamber and the second cylinder chamber being separated by the piston;
a first proportional valve assigned only to the first hydraulic cylinder such that the first proportional valve is connected via a first operating pressure line only to the second cylinder chamber of the first hydraulic cylinder;
a second proportional valve assigned only to the second hydraulic cylinder and connected via a second operating pressure line only to the second cylinder chamber of the second hydraulic cylinder, wherein no additional operating pressure lines connect the first proportional valve and the second proportional valve to the first hydraulic cylinder and the second hydraulic cylinder, wherein the first proportional valve and the second proportional valve are each configured as a 4/3 proportional directional control valve with four ports and three switching positions, each of which has two operating ports, one pressure port, one tank return port, and only one solenoid coil, wherein one operating port is connected to the corresponding operating pressure line and the other operating port is connected to a respective control pressure line;
a first hydraulic check valve provided in the first operating pressure line; and
a second hydraulic check valve provided in the second operating pressure line, wherein the first hydraulic check valve and the second hydraulic check valve are each connected with at least one of the control pressure lines.

9. The sprayer boom of claim 8, wherein the first hydraulic cylinder and the second hydraulic cylinder are arranged so that the respective cylinder housing is pivotally connected with the center section, and the respective piston and its piston rod are pivotally connected with the respective boom arm.

10. The sprayer boom of claim 8, further comprising a further hydraulic control system which controls the further hydraulic cylinder, the further control system comprising a hydraulic accumulator branching off from an operating pressure line to the further hydraulic cylinder, which accumulator is connected to the operating pressure line via a throttle.
